(19) United States
(12) Patent Application Publication
(10) Pub. No.: US 2021/0248483 A1
(43) Pub. Date: Aug. 12, 2021

(54) DATA CLASSIFICATION AND CONFORMATION SYSTEM AND METHOD

(71) Applicant: Shark & Cooper LLC, Las Vegas, NV (US)

(72) Inventors: Piotr Tomasik, Las Vegas, NV (US); Nathan Sculli, Las Vegas, NV (US)

(21) Appl. No.: 16/789,384

(22) Filed: Feb. 12, 2020

(51) Int. Cl. G06N 5/02

(52) U.S. Cl. CPC G06N 5/02

(57) ABSTRACT

A data classification and conformation system conforms data for safe use at one or more service provider devices. The data classification and conformation system automatically detects and classifies form data to properly conform the form data for use at a service provider device. Data is typically conformed by sanitization, validation, normalization, or various subsets thereof. One or more data routing mechanisms are provided to allow a service provider to integrate a data classification and conformation system with one or more service provider devices with minimal effort.

### BACKGROUND OF THE INVENTION

### 1. Field of the Invention

The invention relates to data protection systems and in particular to a data classification and conformation system and methods therefor.

### 2. Related Art

Unusable data is sometimes transmitted in client-server, server-server and other architectures where data can be accepted from one or more external and internal sources. Beyond uselessness, such unusable data may be intended to cause harm in some cases.

From the discussion that follows, it will become apparent that the present invention addresses the deficiencies associated with the prior art while providing numerous additional advantages and benefits not contemplated or possible with prior art constructions.

### SUMMARY OF THE INVENTION

A data classification and conformation system is disclosed herein. As will be described herein, a data classification and conformation system conforms data such that it may be safely used at one or more service provider devices.

Various embodiments of a data classification and conformation system are disclosed herein. For example, in one exemplary embodiment, a data classification and conformation system in communication with one or more service provider devices, where the service provider devices generate interface data for transmission to one or more client devices, is disclosed.

In this embodiment, the data classification and conformation system comprises one or more storage devices storing classification information and validation information, one or more data routing mechanisms, and one or more processors.

The data routing mechanisms are at the client devices. When executed, the data routing mechanisms modify at least a portion of the interface data to cause form data including field input data collected at the client devices to be transmitted to the data classification and conformation system upon submission at the client devices.

The processors receive the form data, classify the form data using the classification information, conform the form data to one or more predefined specifications using the validation information to generate conformed form data, and replace at least a portion of the form data with the conformed form data to generate integrated form data. The integrated form data is transmitted to the service provider devices.

The data routing mechanisms may be transmitted to the client devices along with the interface data. In addition, conforming the form data to the predefined specifications may include sanitization, validation, and normalization of the form data. Also, classifying the form data may comprise generating one or more hashes of distinct subsets of the form data until at least one of the hashes matches a classification identifier in the classification information. Alternatively, classifying the form data may comprise comparing one or more distinct subsets of the form data until at least one of the subsets matches a portion of the classification information.

The form data may be added to the classification information after classification of the form data. In addition, the storage devices may also store error information comprising one or more predefined error messages associated with one or more conformation errors. One or more of the predefined error messages may be transmitted when the form data cannot be conformed to the predefined specifications.

In another embodiment, a data classification and conformation system comprises one or more storage devices storing classification information and validation information, one or more data routing mechanisms executed at the client devices or the service provider devices, and one or more processors. The data routing mechanisms detect and transmit form data within the interface data.

The processors receive the form data, classify the form data using the classification information, conform the form data to one or more predefined specifications using the validation information to generate conformed form data, and replace at least a portion of the form data with the conformed form data to generate integrated form data. The integrated form data is transmitted to the service provider devices.

The data routing mechanisms, when executed at the client devices or the service provider devices, may modify at least a portion of the interface data to cause form data including field input data collected at the client devices to be transmitted to the data classification and conformation system upon submission at the client devices.

In addition, conforming the form data to the predefined specifications includes sanitization, validation, and normalization of the form data. Also, classifying the form data may comprise generating one or more hashes of distinct subsets of the form data until at least one of the hashes matches a classification identifier in the classification information. Alternatively, classifying the form data may comprise comparing one or more distinct subsets of the form data until at least one of the subsets matches a portion of the classification information.

The form data may be added to the classification information after classification of the form data. In addition, the storage devices may also store error information comprising one or more predefined error messages associated with one or more conformation errors. One or more of the predefined error messages may be transmitted when the form data cannot be conformed to the predefined specifications.

Various methods for classifying and conforming data are also disclosed herein. For instance, in one exemplary embodiment a method for classifying and conforming data for one or more service provider devices, where the service provider devices generate interface data for transmission to one or more client devices, is disclosed.

In this embodiment, the method comprises transmitting one or more data routing mechanisms to the client devices for execution at the client devices and modifying at least a portion of the interface data at the client devices with the data routing mechanisms to cause form data including field input data collected at the client devices to be transmitted to a data classification and conformation system upon submission at the client devices.

The method also includes receiving the form data from the client devices at the data classification and conformation system, classifying the form data using the classification information, and conforming the form data to one or more predefined specifications using validation information of the data classification and conformation system to generate conformed form data.

At least a portion of the form data may be replaced by the conformed form data to generate integrated form data. The integrated form data is then transmitted to the service provider devices.

The data routing mechanisms may be transmitted to the client devices along with the interface data. In addition, conforming the form data to the predefined specifications may include sanitization, validation, and normalization of the form data.

Classifying the form data may comprise generating one or more hashes of distinct subsets of the form data until at least one of the hashes matches a classification identifier in the classification information. Alternatively, classifying the form data may comprise comparing one or more distinct subsets of the form data until at least one of the subsets matches a portion of the classification information.

Error information comprising one or more predefined error messages associated with one or more conformation errors may also be provided. The of the predefined error messages may be transmitted when the form data cannot be conformed to the predefined specifications.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram of an exemplary data classification and conformation system in an environment of use;

FIG. 2 is a block diagram of an exemplary data classification and conformation system;

FIG. 3 illustrates an exemplary interface;

FIG. 4 illustrates an exemplary interface;

FIG. 5 is a flow diagram illustrating operation of an exemplary data classification and conformation system;

FIG. 6 is a flow diagram illustrating operation of an exemplary data classification and conformation system;

FIG. 7 is a flow diagram illustrating operation of an exemplary data classification and conformation system; and

FIG. 8 is a flow diagram illustrating operation of an exemplary data classification and conformation system.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As will be described further herein, the data classification and conformation system generally comprises an independent system that processes incoming data such that the data can be safely used. A data classification and conformation system will typically automatically classify and ensure conformity of data. Accordingly, a data classification and conformation system provides data that conforms to predefined specifications while excluding unusable data, including irrelevant and harmful data.

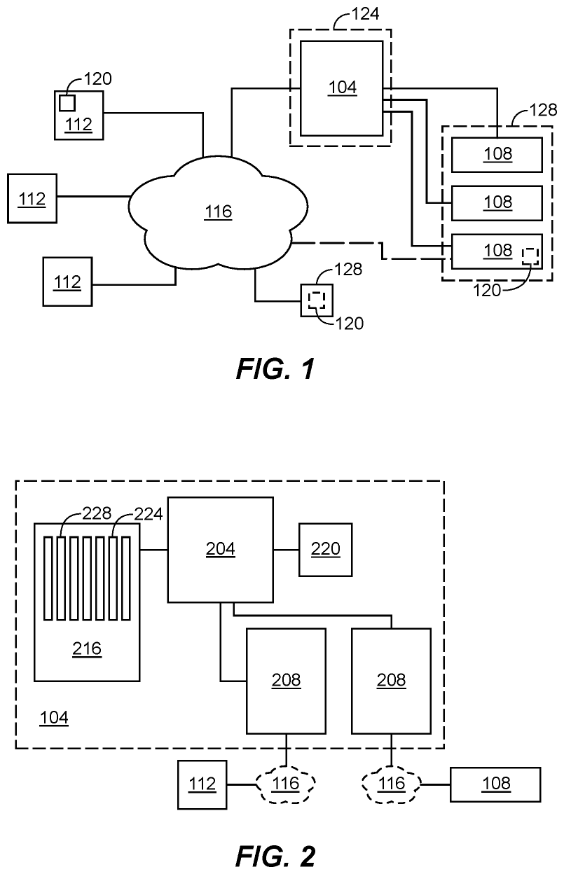

FIG. 1 illustrates an exemplary data classification and conformation system 104 in an exemplary environment of use. A data classification and conformation system 104 will typically be in an interconnected environment, such as a network environment, with one or more client devices 112 and one or more service provider devices 108. Data transmitted by client devices 112 may be used by service provider devices 108 to provide services to the client devices, to other users, or both for various purposes. For example, a service provider device 108 may be a web, database, application, or other back end device providing corresponding services to a client device 112.

Communication with one or more client devices 112 and one or more service provider devices 108 may occur through one or more of the same or distinct networks 116 and wired or wireless communication links thereof. Some exemplary networks 116 include local area networks, wide area networks, and the Internet. As can be seen, in some cases, a service provider device 108 may be directly connected to a data classification and conformation system 104, if desired. It is contemplated that one or more client devices 112 may also be directly connected.

In general, data transmitted from a client device 112 to a service provider device 108, or vice versa, will typically be routed such that at least some of the data is first received by a data classification and conformation system 104, rather than the intended service provider device or client device, as the case may be. In this manner, data can first be conformed to predefined specifications by a data classification and conformation system 104, such as by sanitization, validation, normalization, or various subsets thereof. Conformed data can then be transmitted to and safely used at a service provider device 108.

One or more data routing mechanisms 120 may be provided to route data such that it is first received by a data classification and conformation system 104. In some embodiments, only a subset of data intended for a service provider device 108 may be first routed to a data classification and conformation system 104, while in other embodiments all data may be first routed to a data classification and conformation system.

As shown by the communication link depicted in a broken line from the network 116 of FIG. 1, data may still be communicated from client devices 112 to service provider devices 108 without first being transmitted to a data classification and conformation system 104. For example, data not relevant to data conforming purposes need not be transmitted to a data classification and conformation system 104. Additional details regarding data routing mechanisms 120 will be provided below.

FIG. 1 also illustrates an exemplary topology. As can be seen, a data classification and conformation system 104 will typically be independent of service provider devices 108. With reference to FIG. 1, it can be seen that a data classification and conformation system 104 is be at a first site 124, while its one or more associated service provider devices 108 are at a second site 128 remote from the first site. A site may be defined by a boundary such as a physical boundary or other predefined boundary. For example, a site may be a building, municipality, or other geographical location.

A data classification and conformation system 104 is also independent in the sense that it will typically operate independently of a service provider device 108 and remains operational regardless of the operational state of service provider devices. In addition, a single data classification and conformation system 104 may service a plurality of service provider devices 108 operated by the same or different parties for the same or distinct purposes.

FIG. 2 illustrates components of an exemplary data classification and conformation system 104. It is contemplated that, in one or more embodiments, a data classification and conformation system 104 may be a server, network appliance, or the like.

A data classification and conformation system 104 may comprise one or more processors 204. A processor 204 may be a CPU or other microprocessor, microcontroller, ASIC, FPGA, or the like. In general, a processor 204 will execute machine readable code comprising instructions that, when executed, provide the functionality disclosed herein.

Such machine readable code will typically be stored on a non-transient storage device, excluding carrier waves and signaling, for retrieval and execution by a processor 204. One or more internal or external storage devices 216 may be provided to store machine readable code 224. Some exemplary storage devices 216 include magnetic, optical, and flash-based storage devices. It is contemplated that various storage devices 216, including those now know and later developed may be used. It is noted that, alternatively, or in addition, machine readable code may be integrated into a processor 204, such as in the case of an ASIC or FPGA, in some embodiments.

In addition to machine readable code 224, a storage device 216 may store various information 228 related to the operation of a data classification and conformation system 104. For example, and as will be described further below, one or more storage devices 216 may store classification information associating particular form data with a classification, error information including predefined error messages, and validation information that can be queried in validating various input. It is contemplated that such information may be stored in one or more databases or in other data storage formats on a storage device 216.

A plurality of communication devices 208 may be provided in one or more embodiments to allow communication between a data classification and conformation system 104 and one or more client devices 112, and one or more service provider devices 108. In one or more embodiments, a first communication device 208 communicates with one or more client devices 112, while a second communication device 208 communicates with one or more service provider devices 108. It is noted that, a single communication device 208 may communicate with both client devices 112 and service provider devices 108 as well.

A communication device 208 may be a wired or wireless communication device. Some exemplary communication devices 208 include, network interface cards, wired or wireless modems, and wired or wireless transmitters, receivers, and transceivers. It is contemplated that various communication protocols, now known or later developed, may be used. As shown by the broken line depiction thereof, communication may optionally occur via one or more of the same or distinct networks 116.

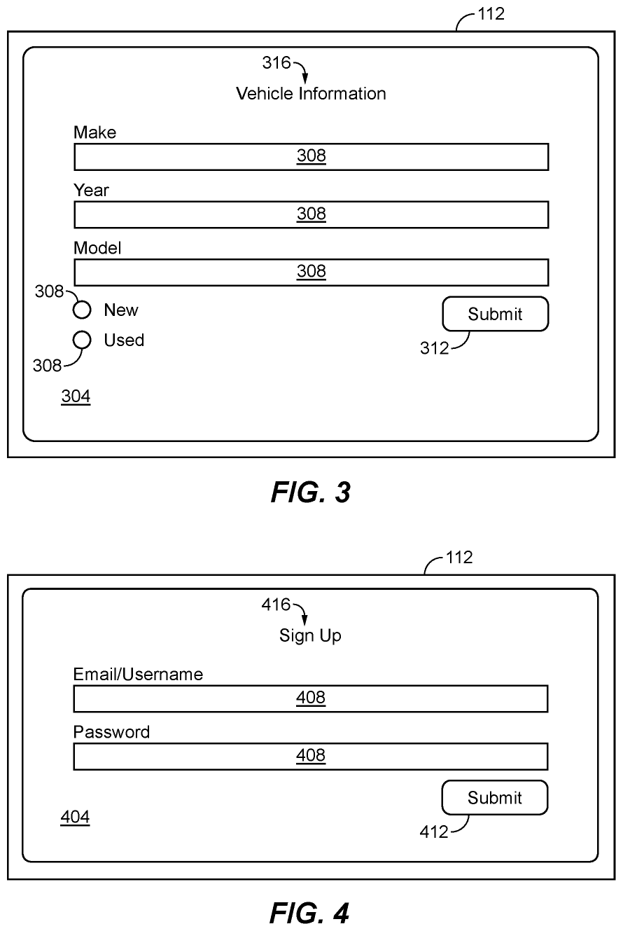

FIGS. 3 and 4 illustrate exemplary interface screens 304, 404. Interface screens 304, 404 will typically be presented at client devices 112, such as on a display screen or other output device thereof. A client device 112 may also comprise one or more input devices, such as to receive user input, and one or more communication devices to allow wired or wireless communication. Some exemplary client devices 112 include desktop or laptop computers, smartphones, tablets, gaming machines, kiosks, terminals, entertainment systems, and the like.

As can be seen, an interface screen 304, 404 may have one or more fields 308, 408 that receive input, typically from a user. Though shown as text entry and radio button fields 308, 408, it is contemplated that a field may be various other types, such as toggles, selectors, radio buttons, date pickers, and other input types. A field 308, 408 may receive various types of data as well, such as dates, indexes, numbers, strings, and binary data, such as image, audio, and video data. One or more controls 312, 412 may also be provided to initiate transmission of collected input. As shown for instance, a control 312, 412 in the form of a “Submit” button is provided to initiate such transmission when engaged.

Interface screens 304, 404 will typically be defined by interface data. For example, interface data may be the HTML, CSS, JAVASCRIPT, and other content of a webpage. Form data comprising field data, which defines one or more fields 308, 408, may be associated with interface data, such as by forming at least a portion thereof. Field data generally indicates the presence of one or more fields 308, 408 and may also or alternatively define a type for the fields, e.g., text, select, radio, or button. Field input data representing user or other input received by one or more fields 308, 408 may also be part of form data.

In one or more embodiments, form data may be explicitly delineated, such as by keywords, tags, or other identifiers. For example, in HTML, form data and related meta data thereof may be found within “<form>” and “</form>” identifiers. Fields 308, 408 and related meta data may also be explicitly delineated. For example, in HTML, fields 308, 408 may be identified by “<input>” identifiers, while related meta data may be identified by “prompt,” “value,” or “title” identifiers. Though described in the foregoing as text, it will be understood that an identifier may be in different formats, including numerical and binary formats.

Form data may also include related meta data 316, 416 that, generally speaking, provides information about one or more fields 308, 408 to allow the fields to be classified for purposes of determining what type of input should be received in the fields. For example, related meta data 316, 416 may comprise a value, label, prompt, title, description, or other information about a field 308, 408, associated therewith. Related meta data 316 may also comprise the location, including relative location, of a field 308, 408 relative to other fields or related meta data items.

It is contemplated that related meta data 316 may also include headings, labels, titles, or other information in or associated with interface data that indicates what type of input one or more fields 308, 408 should receive. For example, a URL, title, or other content of interface data may be used as related meta data.

Referring to FIG. 3, the interface screen 304 includes form data that defines the fields 308 thereof as well as related meta data in the form of labels for each of the fields, namely, “Make,” “Year,” “Model,” and “New/Used.” The related meta data 316, in the form of the heading, “Vehicle Information” is also present in the form data. In this case, the “Vehicle Information” related meta data indicates that the fields 308, such as the “Make,” “Model,” and “New/Used” fields, should receive vehicle information. A data classification and conformation system can accordingly ensure that input received via the interface screen 304 conforms to the same, as will be described further below.

The “Year” field 308 also illustrates that the type of input a field should receive may be clear, in some cases, without reference to related meta data. For example, in one or more embodiments, it may be clear that the “Year” field 308 should receive a year as input. Similarly, with reference to FIG. 4, the “Email/Username” and “Password” fields 408 themselves indicate that these fields should receive corresponding input, namely, email or username and a password.

It is expected that, in many cases, at least some data within interface data will not be form data. For example, various text, images, or other document content that is neither form data or related meta data may be part of interface data. In some embodiments, this excluded data need not be transmitted to a data classification and conformation system. In these embodiments, only form data is transmitted to a data classification and conformation system.

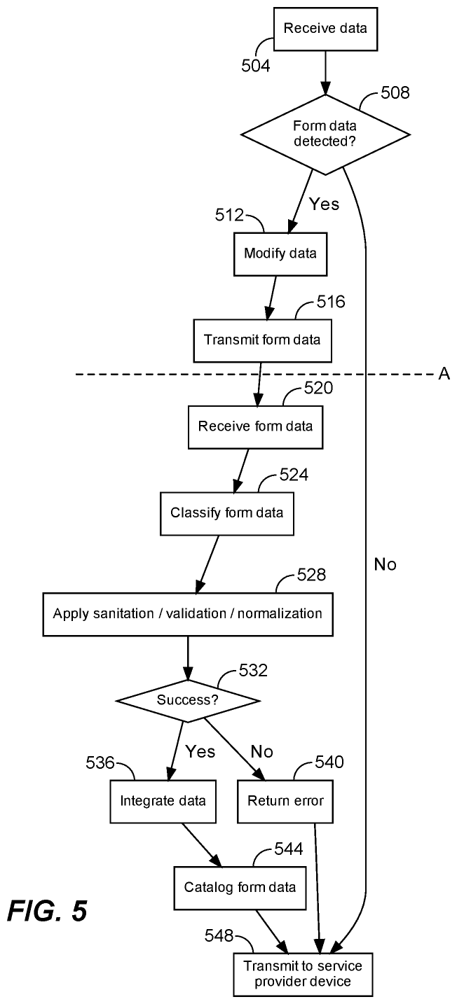

Operation of an exemplary data classification and conformation system will now be described with respect to the flow diagram of FIG. 5 and reference to FIG. 1. With respect to FIG. 5, the steps above line A will typically be performed by a data routing mechanism, such as at a client device, while steps below line A will typically be performed by a data classification and conformation system.

In one or more embodiments, a data routing mechanism 120 may comprise machine readable code stored on a non-transient storage device (excluding carrier waves and other signaling), the instructions of which, when executed, provide the routing functionality described herein.

Some exemplary storage devices include optical, magnetic, and flash-based storage devices. It will be understood that other storage devices, now know or later developed, may be used as well. In some embodiments, the machine readable code may be integrated into a component's circuitry or logic. For example, a processor, such as a CPU or other microprocessor, microcontroller, ASIC, or FPGA may have instructions embedded therein that provide data routing functionality.

As shown by the solid line depiction thereof in FIG. 1, a data routing mechanism 120 will typically be at a client device 112. When executed by a client device, a data routing mechanism 120 may route all, or a particular subset of data intended for a service provider device 108, to a data classification and conformation system 104, as will be described in the following.

At a step 504, data may be received at a client device 112, such as through a communication device thereof. Typically, the data will be from a service provider device 108 and include interface data. For example, the interface data may be a webpage, including HTML, CSS, and JAVASCRIPT (and any binary data, such as images, which make up the webpage).

The interface data received by a client device 112 may have a data routing mechanism embedded 120 therein or otherwise transmitted therewith, for example, in the form of embedded JAVASCRIPT. It is noted that, in some embodiments, a client device 112 may first compile a data routing mechanism 120 to allow execution of the same. In other embodiments, a data routing mechanism 120 may be provided in executable form, such as by being hosted for download as an executable binary at a data classification and conformation system 104.

A data routing mechanism 120 may be hosted, but not executed, at a data classification and conformation system 104. In this manner, a data routing mechanism may be transmitted to various client devices 112 for storage, execution, or both. For example, a data routing mechanism 120 may comprise downloadable JAVASCRIPT code or a binary executable hosted by a data classification and conformation system 104. Service providers can then embed the data routing mechanism 120 in their web pages for execution at client devices 112.

When executed by the client device, the data routing mechanism will typically determine whether form data, including any related meta data, exists within the received data. This is illustrated at a decision step 508.

Form data may be detected in various ways. As stated, a “<form>” or other identifier may delineate the beginning and end of a form. In addition, form data may be identified by fields. For example, an “<input>” or other identifier may identify a field or a group of fields. It is contemplated that a “keyword,” regular expression, or other search may be used to determine whether form data is present.

If no form data is detected at decision step 508, the data received at step 504, or a portion thereof, may be forwarded to a service provider device at a step 548. For example, if a user has clicked a link of a webpage, the URL thereof may be transmitted to a service provider device 108 at a step 548.

If form data is detected, the same may be modified at a step 512 to generate modified interface data. A data routing mechanism 120 may modify interface data, such as form data thereof, to cause data to be first transmitted to a data classification and conformation system 104. For example, a data routing mechanism 120 may detect and modify form POST and GET actions within interface data such that field input data collected at one or more fields, when submitted at a client device 112, is transmitted to a data classification and conformation system 104 as opposed to a service provider device 108. The modified interface data may then be presented at the client device 112.

The modification of form data in this manner may automatically occur when a data routing mechanism 120 is executed. This allows service providers to avoid the need to specifically include the instructions to send data to a data classification and conformation system 104 in their service provider devices 108. Accordingly, in one or more embodiments, a data routing mechanism 120 is fully operational without need to modify a service provider device's operation other than to embed a data routing mechanism.

At a step 516, data may be transmitted to a data classification and conformation system 104 according to the modified interface data. Transmission may be initiated when a user submits information at a client device 112. For example, transmission at step 516 may be initiated when a user clicks a “Submit” button, such as shown in FIGS. 3 and 4. The transmitted form data will also include any field input data that was received by one or more fields associated with the form data. The data classification and conformation system 104 receives this data, such as at a communication device thereof, as shown at a step 520.

At a step 524, form data may be classified. As will be described further below, classification will define what type of input should be received by associated fields. As described with respect to FIG. 3 for example, a “Vehicle Information” form should receive “Make,” “Model,” “Year,” and other input that corresponds to vehicle brands, the models thereof, and production years.

At a step 528, field input data may be conformed. This may occur by applying sanitization, validation, normalization, or various subsets to field input data to produce conformed data. Typically, one or more of these processes will be applied to conform user or other input represented by field input data, though it is contemplated that other form data may be conformed as well. For example, initial field values set by a service provider may be conformed to prevent misconfigured initial values from disrupting operation of a service provider device.

Sanitization ensures the input is not harmful or does not contain extraneous data. For example, sanitization may remove embedded SQL statements, white space, quotations, and the like. This helps ensure that, when used by a service provider device, unexpected results are avoided. For example, sanitization can prevent damage from embedded SQL statements, system crashes from otherwise valid input that contains extraneous data, or both. It is contemplated that sanitization may occur by detecting extraneous data via keyword, regular expression, or other searching.

Validation ensures the input is valid for a particular field. For example, a “Year” field should receive input representing a single year, whether the input comprise a numerical value or a textual value, e.g., “1990” or “nineteen ninety.” If related meta data indicates a constraint should be applied, validation may include confirming the constraint is not violated. For example, if “Vehicle Information” is expected, a “Year” field may be constrained to years where vehicles are or have been produced. As another example, validation may ensure a “Username/Email” field and “Password” field contains a valid username, email address, and a strong password.

A data classification and conformation system will typically comprise validation information, such as in the form of a database, including listings of valid input of various kinds. At least some of these listing may be relational. For example, a data classification and conformation system may have validation information comprising a listing of vehicle makes associated with their models and production years for use in validating input relating to vehicles. Other examples include, address listings of valid street names, numbers, and postal codes, product listings/expected price ranges of available products, game and team listings, and telephone number listings of valid telephone numbers.

Normalization ensures the input is in a format expected by a service provider device, or in a format that a service provider device can properly accept. For example, with regard to a “Year” field, normalization may convert year input into a numerical representation even if the input is textual, e.g., converting “nineteen ninety” to “1990” for use by a service provider device. Whitespace characters, such as leading and trailing spaces, may be removed as well during normalization.

It is contemplated that normalization may include other transformations of input as well. For example, normalization may convert input comprising a list of one or more words into a category. To illustrate, input comprising “car, truck, train, and airplane” or various subsets thereof may be converted into an encompassing category, such as “vehicles.” This may be accomplished by determining one or more common characteristics of the input and identifying a category that includes these characteristics, such as in a database or other record.

As another example, normalization may convert input comprising a regular expression or other parameter string/data into one or more strings (or other data) that match the parameter string. To illustrate, a parameter string comprising a cron time and date entry for the UNIX cron daemon may be converted into one or more dates that match the entry, including any asterisk or other wildcard fields. As can be seen, normalization may also occur for various command strings or the like having predefined formats.

Typically, conformation will proceed in sequence, namely, sanitization followed by validation followed by normalization. It is contemplated that various other sequences of operation may be used in the various embodiments of a data classification and conformation system. Sanitation will typically be the initial step in some embodiments, to ensure safe operation of a data classification and conformation system 104.

Though described herein primarily as occurring subsequent to validation, it is contemplated that normalization may occur before validation (including before sanitization), after validation, or both.

At a decision step 532, if conformation is successful, conformed data may be integrated into the original form data for transmission to a service provider device. For example, validated, sanitized, and normalized field input data for a particular field may replace the original field input data in the form data during integration. To illustrate, user input of “nineteen ninety” in the “Year” field may be replaced by “1990” prior to transmission to a service provider device at a step 536.

If conformation is unsuccessful at decision step 532, an error may be returned at a step 540. In one or more embodiments, an error message may be transmitted to the client device at step 540. The error message may simply indicate an error has occurred. A description of the error may be present in an error message as well. Such error description may be predefined and stored as error information in a storage device, such as in a database thereon, of a data classification and conformation system.

Error descriptions will generally be predefined information helpful in addressing an error. For example, an error description may indicate that particular input is invalid for a particular field, how the input is invalid, or both. Error descriptions may be associated with expected validation, sanitization, and normalization issues.

For example, an error description may indicate a valid range for input to a particular field if the input is outside the constraint for such field but is otherwise valid. Another error description may be issued, identifying the input is invalid, if the input is not valid regardless of any constraints. For example, the error description is different if “coffee” is received as input in a “Year” field as opposed to “1049” in the case of a vehicle information form.

An error message may be presented at a client device 112 to allow users to address the same. As can be seen, a service provider device 108 therefore may rely upon a data classification and conformation system 104 for handling errors. Such error information may be transmitted to a service provider device 108 at step 548 for forwarding to a client device 112 in one or more embodiments.

At a step 544, form data may be cataloged for future use. In general, cataloging will be performed to avoid the need to repeatedly classify the same form data. In one or more embodiments, cataloging may occur by storing classification information for particular form data and the fields, related meta data, or both thereof. Classification information may be stored on a storage device of a data classification and conformation system, such as in a database thereon.

Classification information may include one or more fields identified in previously classified form data associated with the type of input such fields should receive, such as in the form of one or more constraints. A classification identifier, such as a hash, or other identifier may be generated, such as with at least the field identification information, to subsequently identify the form data in a catalog. It is contemplated that a classification identifier may also comprise or be generated by hashing additional or other information, such as related meta data (e.g., URLs, titles, prompts, and headings).

Exemplary classification information is shown in the following table. As can be seen, multiple classification identifiers may be generated for particular form data by including various combinations of fields and related meta data. This allows new form data, that may have the same classification, to be more easily matched to a classification identifier even when it has variations relative to other form data of the same classification. In addition, classification identifiers may be for form data having only a single field, such as shown below.

| Classification Identifier/Description | Fields and Constraint | Related Meta Data |
|---|---|---|
| b42d27e6ae878b32c6c070bcc209dec3 | Make: Vehicle Brand (Text) | Title: “Vehicle |
| Vehicle Information Form | Model: Vehicle Model (Text) | Information” |
| | Year: Year (1920-Present) | Labels: “Make,” |
| | New or Used: Binary | “Model,” “New/Used” |
| 9eb7db0d44cfb3bcee50f181db9f9d1d | Username/Email: Username or | Title: “Sign Up” |
| Sign Up Form | Email Address (Text) | Labels: “Username,” |
| | Password: Password (Strong) | “Email,” “Password” |
| 55ca38d9753d8fbe51478813d9395e52 | Username/Email: Username or | |
| Sign Up Form | Email Address (Text) | |
| | Password: Password (Strong) | |
| 49841afd38df98c728c73627baa82372 | First Name: Text | Title: “Identification |
| Personal Information Form | Last Name: Text | Information” |
| | SSN: Numbers (Format: xxx- | |
| | xx-xxxx) | |
| | Date of Birth: Date | |
| afc3f3940118286704d8924149f5f947 | Captcha: Text | |
| Captcha Form | | |

At a step 548, integrated form data may be transmitted to the service provider device, as described above.

It will be understood that, though presented in a particular sequence, steps herein may be performed in various orders or simultaneously. For example, integration of form data at step 536 and cataloging at step 544 may occur simultaneously or in reverse order than that shown. Likewise, transmission of integrated form data at step 548 may occur immediately after integration is completed at step 536.

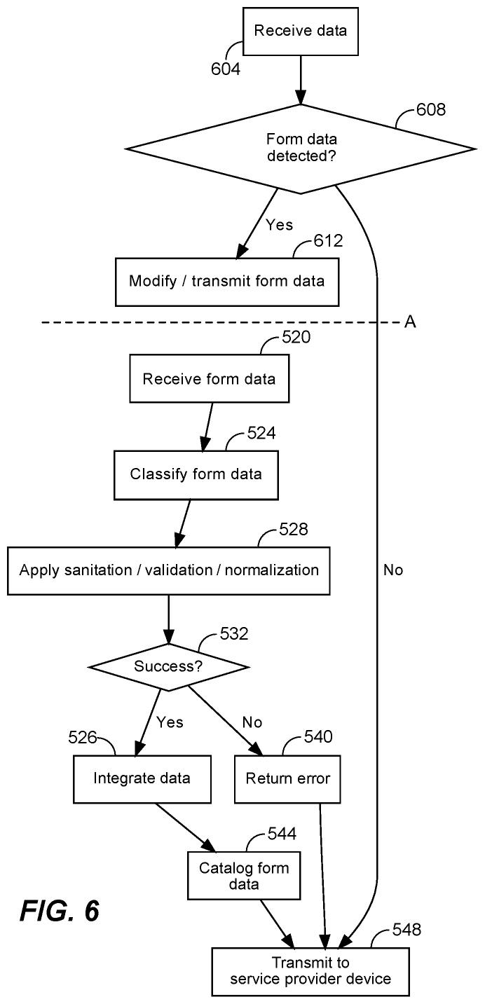

Operation of another exemplary data classification and conformation system will now be described with respect to the flow diagram of FIG. 6 and with reference to FIG. 1. With respect to FIG. 6, the steps above line A will typically be performed by a data routing mechanism 120 at a service provider device 108 or standalone device 128, while steps below line A will typically be performed by a data classification and conformation system 104.

As shown by the broken line depictions in FIG. 1, it is contemplated that a data routing mechanism 120 may optionally be at a service provider device 108 or at a standalone device 128. For example, a data routing mechanism 120 may be part of or neighbor a proxy, web framework, or server module at a service provider device 108 or standalone device 120. Though described with respect to service provider devices 108 and standalone devices 128, it is contemplated that a data routing mechanism 120 may be at a data classification and conformation system 104 in some embodiments.

At a step 604, data may be received at a data routing mechanism 120 from a service provider device 108. Such data will typically include interface data. At a decision step 608, it may be determined whether form data exists in the interface data. This may occur as described above with respect to decision step 508 of FIG. 5. For example, a data routing mechanism 120 may be executed by a service provider device 108 or standalone device 128 to detect form data by performing one or more searches for the same.

If form data is detected, modification and transmission may occur at a step 612. To illustrate, interface data served by a service provider device 108 in the form of a webpage may be received at a data routing mechanism 120 where form data thereof may be detected. The interface data, such as the form data thereof, may then be modified so as to cause a client device to transmit data to a data classification and conformation system 104 rather than the service provider device 108.

For example, interface data, such as form data, may be modified such that GET or POST actions resolve at a data classification and conformation system 104, such as described above. The modified interface data is then transmitted to a client device 112. Field input data captured through the modified interface data at a client device 112, once submitted, is then transmitted a data classification and conformation system 104 as opposed to a service provider device 108 according to the modified interface data.

It is noted that the functionality of various embodiments of a data routing mechanism 120 at various devices has been described above for explanatory purposes. Accordingly, the functionality described herein need not be limited by the device at which a data routing mechanism 120 is executed or resides and that various combinations of the functionality disclosed herein may be provided by a data routing mechanism 120 at a variety of devices.

At a step 520, form data is received at a data classification and conformation system 104. In the embodiment of FIG. 6, such form data will typically be received from a client device 112. The form data will typically include the field input data captured through the modified interface data described above. Thereafter, form data may proceed through steps 524 through 548 as described above in connection with FIG. 5, resulting in the transmission of integrated form data to a service provider device 108. If no form data is detected, the received data, or other data, may be transmitted to a service provider device 108, as also described with respect to step 548 of FIG. 5.

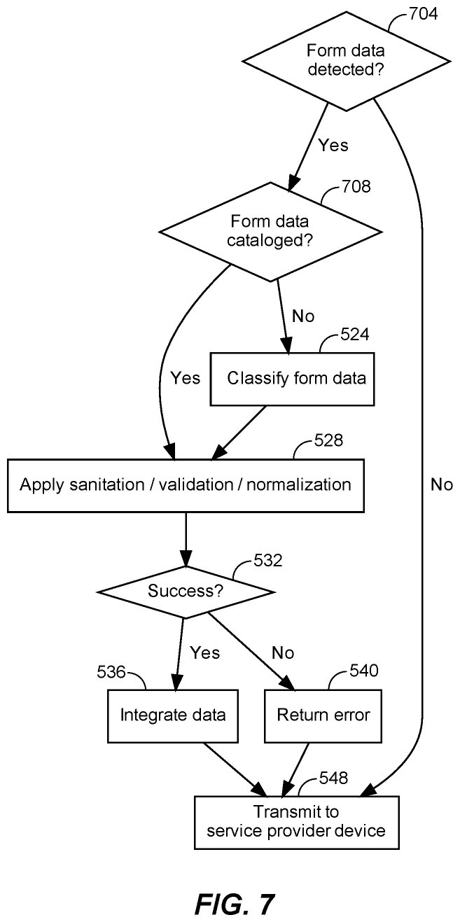

FIG. 7 illustrates operation of an exemplary data classification and conformation system assuming some classification information exists. Typically, a data classification and conformation system will have preset classification information, such as classification information for a number of commonplace fields or groups of fields and variations thereof. New form data may be added to classification information as new form data is encountered and classified.

At a decision step 704, if form data is detected, it may be determined whether the form data has been previously cataloged at a decision step 708. This may occur by determining whether an identifier of the form data, namely, a matching classification identifier, is already present within the classification information of a data classification and conformation system.

In cases where a classification identifier is a signature, the fields, related meta data, or both related to the form data may be hashed, such as will be described further below, to generate a classification identifier for use in querying existing classification information for a matching classification identifier. If a match is found, this indicates the form data has already been cataloged.

If form data has been previously cataloged, conformation may be applied to the form data at step 528, as described above. If not previously cataloged, the form data may be classified and subsequently processed at steps 524 through 548 as described above. Though not illustrated in FIG. 7, it is noted that previously uncatalogued form data may be cataloged after successful conformation at decision step 532.

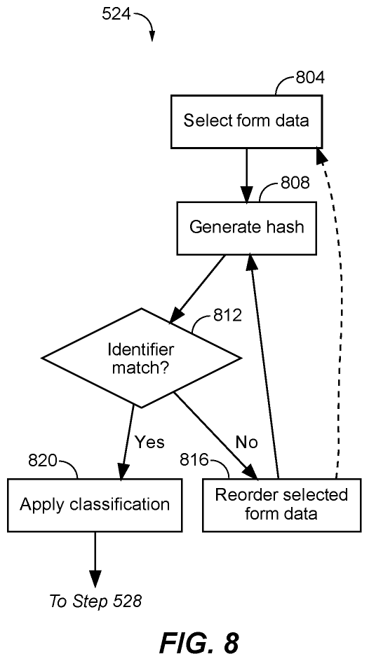

FIG. 8 illustrates operation of an exemplary data classification and conformation system during classification of form data. As described above, classification may occur as part of form data cataloging as well as classification.

At a step 804, a selection of form data is generated. For example, one or more fields of the form data may be selected. It is contemplated that, rather than a subset of the form data, all form data may be selected in some cases. Related meta data, or a subset thereof, may also be selected, such as titles, prompts, and values associated with the fields.

At a step 808, a hash may be generated with the selected form data to generate a classification identifier. At a decision step 812, the classification identifier may be compared to existing classification information to determine whether a matching classification identifier exists. If no matching classification identifier is found, one or more individual items of selected form data may be reordered at a step 816, and a new hash may be generated with the same, at step 808, for classification identifier matching at decision step 812. In this manner, form data comprising the same or similar fields, related meta data, or both may be assigned the same classification regardless of the sequence of how such items are arranged.

As can be seen from the following table illustrating exemplary classification information, a classification identifier exists for a “Sign Up” form data having fields in various sequences and various sets of related meta data.

| Classification Identifier/Description | Fields and Constraint | Related Meta Data |
|---|---|---|
| b42d27e6ae878b32c6c070bcc209dec3 | Make: Vehicle Brand (text) | Title: “Vehicle |
| Vehicle Information Form | Model: Vehicle Model (text) | Information” |
| | Year: Year (1900-Present) | |
| 9eb7db0d44cfb3bcee50f181db9f9d1d | Username/Email: Username or | Title: “Sign Up” |
| Sign Up Form | Email Address (text) | |
| | Password: Password (strong) | |
| 55ca38d9753d8fbe51478813d9395e52 | Username/Email: Username or | |
| Sign Up Form | Email Address (text) | |
| | Password: Password (strong) | |
| db5e33c5bdb87c52641a3ad475f86162 | Password: Password (strong) | Title: “Sign Up” |
| Sign Up Form | Username/Email: Username or | |
| | Email Address (text) | |

As shown in FIG. 8, reordering and hashing of selected form data at steps 808 and 816 as well as classification identifier matching at decision step 812 may occur repeatedly until a signature match is found. Reordering and hashing will typically be terminated when the possible combinations of ordering the selected form data is exhausted without a match. As indicated by the broken line from step 816 to step 804, different selections of form data, related meta data, or both may be attempted until a matching classification identifier is found as well.

When a matching classification identifier is found, the corresponding classification may be applied to the form data at a step 820. This may occur by assigning the matching classification identifier to the form data. Once the classification of form data is known, the process may continue to step 528 where conformation occurs, as described above.

It is contemplated that classification can occur in other ways as well. For example, one or more fields, related meta data, or both of form data may be compared to that in the classification information to find a matching classification for the form data. This comparison may occur repeatedly as well with different portions of form data being used for comparison purposes, until a matching classification is found.

If no classification can be automatically identified, additional information may be requested from a service provider to properly classify form data. For example, a service provider may manually select or input a classification for their form data. In addition, it is contemplated that a service provider may review classifications of their form data and confirm or update the same. For example, a service provider may change a classification entirely or modify a subset thereof, such as one or more constraints and associated error information. A service provider may access a data classification and conformation system for such purposes via one or more client devices.

As can be seen, a data classification and conformation system is advantageous in that, and among other things, it helps ensure safe operation of service provider devices with minimal effort by service providers. A data classification and conformation system also benefits users by providing relevant error information, even in cases where a service provider has not setup its service provider devices to do the same.

Though described herein with respect to particular technologies, such as HTTP technologies, it will be understood that a data classification and conformation system may be used in various environments where conformation of user or other input is advantageous, such as in cases where third party systems or remote systems must communicate with one another.

In addition, the terms service provider device and client device are not intended to limit the disclosure herein to any particular hardware. It is contemplated that, in some embodiments, service provider devices and client devices may be the same hardware. In addition, it is contemplated that a data classification and conformation system may treat a client device as a service provider device, and vice versa, to conform data bidirectionally.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A data classification and conformation system in communication with one or more service provider devices, wherein the one or more service provider devices generate interface data for transmission to one or more client devices, the data classification and conformation system comprising:
one or more storage devices storing classification information and validation information;
one or more data routing mechanisms at the one or more client devices, wherein the one or more data routing mechanisms, when executed, modify at least a portion of the interface data to cause form data including field input data collected at the one or more client devices to be transmitted to the data classification and conformation system upon submission at the one or more client devices; and
one or more processors that:
receive the form data;
classify the form data using the classification information;
conform the form data to one or more predefined specifications using the validation information to generate conformed form data; and
replace at least a portion of the form data with the conformed form data to generate integrated form data;
wherein the integrated form data is transmitted to the one or more service provider devices.

2. The data classification and conformation system of claim 1, wherein the one or more data routing mechanisms are transmitted to the one or more client devices along with the interface data.

3. The data classification and conformation system of claim 1, wherein conforming the form data to the one or more predefined specifications includes validation, sanitization, and normalization of the form data.

4. The data classification and conformation system of claim 1, wherein classifying the form data comprises generating one or more hashes of distinct subsets of the form data until at least one of the one or more hashes matches a classification identifier in the classification information.

5. The data classification and conformation system of claim 1, wherein classifying the form data comprises comparing one or more distinct subsets of the form data until at least one of the one or more subsets matches a portion of the classification information.

6. The data classification and conformation system of claim 1, wherein the form data is added to the classification information after classification of the form data.

7. The data classification and conformation system of claim 1, wherein the one or more storage devices also store error information comprising one or more predefined error messages associated with one or more conformation errors and one or more of the predefined error messages is transmitted when the form data cannot be conformed to the one or more predefined specifications.

8. A data classification and conformation system in communication with one or more service provider devices, wherein the one or more service provider devices generate interface data for transmission to one or more client devices, the data classification and conformation system comprising:
one or more storage devices storing classification information and validation information;
one or more data routing mechanisms that detect and transmit form data within the interface data, the one or more data routing mechanisms executed at the one or more client devices or the one or more service provider devices; and
one or more processors that:
receive the form data;
classify the form data using the classification information;
conform the form data to one or more predefined specifications using the validation information to generate conformed form data; and
replace at least a portion of the form data with the conformed form data to generate integrated form data;
wherein the integrated form data is transmitted to the one or more service provider devices.

9. The data classification and conformation system of claim 8, wherein the one or more data routing mechanisms, when executed at the one or more client devices or the one or more service provider devices, modify at least a portion of the interface data to cause form data including field input data collected at the one or more client devices to be transmitted to the data classification and conformation system upon submission at the one or more client devices.

10. The data classification and conformation system of claim 8, wherein conforming the form data to the one or more predefined specifications includes validation, sanitization, and normalization of the form data.

11. The data classification and conformation system of claim 8, wherein classifying the form data comprises generating one or more hashes of distinct subsets of the form data until at least one of the one or more hashes matches a classification identifier in the classification information.

12. The data classification and conformation system of claim 8, wherein classifying the form data comprises comparing one or more distinct subsets of the form data until at least one of the one or more subsets matches a portion of the classification information.

13. The data classification and conformation system of claim 8, wherein the form data is added to the classification information after classification of the form data.

14. The data classification and conformation system of claim 8, wherein the one or more storage devices also store error information comprising one or more predefined error messages associated with one or more conformation errors and one or more of the predefined error messages is transmitted when the form data cannot be conformed to the one or more predefined specifications.

15. A method for classifying and conforming data for one or more service provider devices, wherein the one or more service provider devices generate interface data for transmission to one or more client devices, the method comprising:
transmitting one or more data routing mechanisms to the one or more client devices for execution at the one or more client devices;
modifying at least a portion of the interface data at the one or more client devices with the one or more data routing mechanisms to cause form data including field input data collected at the one or more client devices to be transmitted to a data classification and conformation system upon submission at the one or more client devices;
receiving the form data from the one or more client devices at the data classification and conformation system;
classifying the form data using the classification information;
conforming the form data to one or more predefined specifications using validation information of the data classification and conformation system to generate conformed form data;
replacing at least a portion of the form data with the conformed form data to generate integrated form data; and
transmitting the integrated form data to the one or more service provider devices.

16. The method of claim 15, wherein the one or more data routing mechanisms are transmitted to the one or more client devices along with the interface data.

17. The method of claim 15, wherein conforming the form data to the one or more predefined specifications includes validation, sanitization, and normalization of the form data.

18. The method of claim 15, wherein classifying the form data comprises generating one or more hashes of distinct subsets of the form data until at least one of the one or more hashes matches a classification identifier in the classification information.

19. The method of claim 15, wherein classifying the form data comprises comparing one or more distinct subsets of the form data until at least one of the one or more subsets matches a portion of the classification information.

20. The method of claim 15, further comprising transmitting one or more predefined error messages associated with one or more conformation errors when the form data cannot be conformed to the one or more predefined specifications.
